(19) United States
(12) Patent Application Publication
(10) Pub. No.: US 2008/0308599 A1
(43) Pub. Date: Dec. 18, 2008

(54) HIGH-START COMPACT SPRING ENERGIZED STAPLER

(75) Inventor: Joel S. Marks, Sherman Oaks, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: WORKTOOLS, INC., Chatsworth, CA (US)

(21) Appl. No.: 11/847,132

(22) Filed: Aug. 29, 2007

Related U.S. Application Data
(60) Provisional application No. 60/943,611, filed on Jun. 13, 2007.

(51) Int. Cl. B25C 5/11

(52) U.S. Cl. 227/132

(57) ABSTRACT

A spring energized stapler includes a “high-start” design wherein a striker has an initial rest position above the staple track. A handle is pressed to energize a power spring while the striker remains stationary. At a predetermined position of the handle, the striker is released to eject a staple. A subassembly of a cage and the power spring provides a preload to the power spring in the rest position. The subassembly is separately movable from the handle to allow a handle pressing end to move father than a cage front end travel distance. A lever links the striker to the power spring to provide leverage upon the power spring. The lever and cage/spring subassembly are nested in a compact assembly. A safety lock includes a two step action to restrict motion of the striker, and fits a notch in a bottom of the striker.

### CROSS-REFERENCE TO RELATED APPLICATIONS

This is a non-provisional application from which priority is based on provisional application No. 60/943,611, filed Jun. 13, 2007, whose entire contents are hereby incorporated by reference.

### FIELD OF THE INVENTION

The present invention relates to spring powered desktop staplers. More precisely, the present invention relates to improvements to a spring-actuated stapler with a striker having an initial “high start” position.

### BACKGROUND OF THE INVENTION

Spring powered staplers and staple guns operate by driving a striker with a power spring. The striker ejects a staple by impact blow. In a desktop stapler, the staple is ejected into an anvil of a pivotably attached base. Two general principles are used. In the first design, the striker has an initial position in front of a staple track. The striker is lifted against the force of the power spring to a position above the staple track. The striker is released to impact and eject the staple. This design may be referred to as a “low-start” stapler.

A second design uses a “high-start” position. That is, the striker has an initial position above the staples loaded on the staple feed track. The power spring is deflected while the striker does not move. At a predetermined position of the power spring deflection, the striker is released to accelerate into and eject a staple. Typical non-spring actuated desktop staplers use a high-start design. However, in such conventional high-start designs, the striker is driven directly by the handle with no power spring to store energy that could be used to drive the striker. There is further no release mechanism for the striker since the striker simply presses the staples directly under handle pressure.

In conventional high-start designs that do use a power spring, the power spring is either unloaded or preloaded in the rest position. Different methods are used to reset the mechanism. U.S. Pat. No. 4,463,890 (Ruskin) shows a desktop stapler with a preloaded spring. Restrainer 42c is an element of the handle and moves directly with the handle. U.S. Pat. No. 5,356,063 (Perez) shows lever 53 with tips 48 engaging striker 24. At a predetermined position of handle 30, lever 53 is forced to rotate out of engagement from striker 24 and power spring 40 forces the striker downward. Swiss Patent No. CH 255,111 (Comorga AG) shows a high-start staple gun with the handle linked to the power spring through a lever. There is no preload restrainer for the power spring so the spring stores minimal energy through the start of the handle stroke. Both references use a releasable link or release latch that is positioned behind the striker and de-linked by a direct pressing force from the handle. British Patent No. GB 2,229,129 (Chang) appears to show a high-start stapler design. However, no functional mechanism to reset the striker is disclosed. Specifically, no linkage is described to lift the striker with the handle in a reset stroke. The lever 3 resembles a lever used in a low-start stapler, but the lever does not lift the striker in any way. Instead, the striker is somehow lifted by a very stiff reset spring, yet no linkage is described to enable a reset spring to lift the striker against the force of the power spring. U.S. Pat. No. 5,335,838 (Harris et al.) shows a high-start pliers style stapler. A “U” shaped flat spring with arms extending forward engages a striker at a top arm, and a bottom arm is moved by a lever to operate a latch to release the striker. There is no means of pre-loading the power spring shown.

It is desirable in a spring actuated stapler to minimize friction so that work used to press the handle is not wasted, but rather available substantially entirely for ejecting and installing staples. A further efficiency interest is to have precise timing of the release action. Specifically, it is desirable that the release occur at precisely the lowest handle position against the housing. At a higher release position, the handle is spaced above the housing; the housing will jump or kick back as the staple is ejected. This is a typical behavior in any spring actuated stapler. As the housing kicks back, the bottom of the stapler is spaced above the paper or other work piece. With this spacing, the striker cannot fully press the driven staple into the paper and anvil below. Another way to characterize this behavior is the energy used to kick up the stapler body is wasted and not available for stapling.

In normal use of a desktop stapler, papers are stacked and attached together. It is sometimes desirable to use the stapler as a tacker, for example, to attach papers to a wood post or a bulletin board. In its tacker configuration, the base must pivot out of the way so the staple exit area can be held against the paper and the bulletin board. But with the base pivoted away, the staple exit area along the striker path is exposed, and it is possible that a staple can be intentionally or unintentionally fired out of the device in the direction of the user or a bystander. To avoid such accidents, in some prior art designs, the base is designed in a way that it cannot pivot away from the body to expose the staple exit area. This prevents exposing the exit area and possible harm to the user or bystanders, but it also precludes the stapler from being used as a tacker.

### SUMMARY OF THE INVENTION

In a preferred embodiment of the present invention, a high-start, spring actuated stapler provides a compact stapler that combines enhanced handle travel for greater leverage with a separately movable spring/cage subassembly to preload the power spring. The cage may be pivotably attached to the housing at a location separate from the pivotable attachment of the handle. As the definition of high-start implies, a striker alternates between an initial rest position above a staple track (the high-start striker start position) and a lower-most position in front of the staple track. A power spring is deflected to store energy by the motion of the handle. At a predetermined position of the handle, the striker is released to accelerate to the lower-most position by urging of the power spring.

A spring/cage subassembly maintains a pre-load upon the power spring in the upper, initial rest position of the stapler. The initial position of the stapler is the normal position of the stapler's components when the stapler is not being used. The cage is separately movable from the handle and pivotably attached at a cage rear end in the housing. The cage at its front end moves slightly less vertical distance than the striker as the power spring moves from the initial rest position above the track to the lower release position in front of the track. The distance is less because the front area of the cage is closer to pivotal attachment of the cage than the striker is to the pivotal attachment. For example, in a preferred embodiment the front area of the cage may move from the initial upper rest position and a lower most position between about 0.30″ to 0.5″ inclusive of the outer limits, with a preferred range of 0.35″ to 0.4″ inclusive of the outer limits.

The spring energized mechanism is preferably nested together to provide a very compact stapler. The housing at a location of the striker can be equal or less than 1.1″ tall from the top of the housing to the bottom of the housing. The striker moves a minimum vertical distance required to drive staples while the handle, at a handle pressing area, moves substantially farther than the striker to achieve increased leverage and lower actuation force. A handle pressing area may include a portion of the handle from a front distal end to a position about 2.5 inches rearward. This corresponds to a normal area a user presses in a standard type desktop stapler. The handle at the pressing area moves between an initial rest position above the housing to a lower, pre-release, position, preferably immediately adjacent to the housing. The handle, at the pressing area may move between about 0.8″ to 1.1″ inclusive of the outer limits, with a narrower range of about 0.8″ to 1″ inclusive of the outer limits being preferred. According to the above discussion, a ratio of motion between the front of the handle to the front of the cage may range from about 1.6 to 3.7 inclusive of the outer limits, with a preferred range of about 2.2 to 2.9 inclusive of the outer limits.

A release mechanism uses a separately movable latch. For example, a release latch is pivotably fitted in the housing and is moved out of engagement with the power at a release point. The power spring is unstable upon the latch at least at the release position of the handle corresponding to a release point; in other words the power spring presses the latch at an off-vertical angle to cause a forward bias upon the latch. A latch holder keeps the latch normally engaged to the power spring to counteract the forward bias. At the release point the handle moves the latch holder out of the way to allow the latch to move forward. The latch is attached in front of the striker, at a pivot point in front of the track near the bottom of the stapler.

A lever links the handle to the power spring to provide enhanced leverage upon the power spring by the handle. The lever is pivotably attached at a front, top of the housing. In the preferred embodiment the lever is of a single thickness sheet metal form; a hinge tab is bent to one side of a lengthwise center line to create an off-center hinge tab to engage the housing. The rear of the lever is oppositely off center at the location that the handle presses the lever. An imaginary force line connecting the rear of the lever to the hinge tab passes over the lever-to-power spring contact location. The forces upon the lever are thus balanced so that the lever does not twist within the housing. For the purpose of explanation, for example, a contrasting design can be imagined where the front hinge tab and rear, handle pressing end are both to the left of the central lever-to-power spring contact location. In this case the lever will twist on its long axis with the left side biased down by the housing and handle, and the right side biased upward by the power spring. Optionally, a low friction linkage connects the handle to the lever rear end. With minimal twisting the lever does not require high force confinement within the housing, this minimizing friction.

The handle is connected to the striker through the lever and power spring. In normal use, the handle presses the striker downward through these connections. Preferably, there is also a tensile connection whereby the handle can pull up on the striker. This is desirable in the instance a jam or other temporary malfunction occurs that causes the striker to be stuck in a lower position; the handle may be used to pull the striker back to its upper rest position. Alternatively, a reset spring with increased stiffness to overcome any expected jam condition can be used. However, this is not as desirable since the user must overcome this extra, normally unneeded, stiffer spring force during every energizing stroke. Hence, it is most preferable that the reset spring is of minimal force as required for a normal reset, and jams are remedied rather by the user pulling the handle up manually. According to the present invention, these tensile connections are simple recess or notch features between components that add minimal cost to the stapler.

The stapler of the present invention in the preferred embodiment includes negligible sliding between components as the handle is depressed and the power spring is deflected. The striker is essentially stationary during this process, and the geometry of the cage, power spring, and handle are selected to maintain primarily pivoting verses sliding actions. This contrasts with some low-start type staplers wherein the striker by design slides within the housing during deflection of the power spring.

To improve the timing of the release action, the release event is actuated by the area of the handle directly under the pressing area. The unstable “passive” release described above allows a low friction action to cause the release event.

The present invention may include a simplified safety lock. Preferably, an extension of the latch holder forms a bias arm to guide a sheet metal safety lock. In the rest position, the safety lock engages a bottom edge of the striker to prevent the striker from moving down. When the body is pressed against the base the safety lock pivots and slides forward and upward in front of the striker so that the striker is free to move downward. The striker preferably includes a tapered notch at the lower edge to allow the safety lock to engage the striker in the notch at a higher position than the lower most edge of the striker. This allows the stapler to stay compact while the safety lock can be long enough to be easily controlled.

### BRIEF DESCRIPTION OF THE DRAWINGS

FIG. 1 is a side elevational view of an exemplary embodiment of a high-start desktop stapler, excluding a base, in an initial rest position with a right side of the housing removed, the striker in the high rest position, and the handle partly in section.

FIG. 2 is the stapler of FIG. 1 in a partially pressed condition with the spring energized and the handle in section.

FIG. 3 is a detail view of a front of the stapler of FIG. 1, in a released condition where the striker is in the lowered position and the handle is abutting the housing.

FIG. 4 is an enlarged detail elevation view of the stapler of FIG. 3, showing the body pressed against a base and a safety lock retracted and with the striker in the lower, released position.

FIG. 5 is the view of FIG. 4 in front, bottom perspective, absent the latch and base.

FIG. 6 is the view of FIG. 4, in rear, bottom perspective, absent the base.

FIG. 7 is a perspective view of a safety lock.

FIG. 8 is a rear elevation of a striker.

FIG. 9 is a front perspective view of a latch holder.

FIG. 10 is a rear perspective view of the latch holder of FIG. 9.

FIG. 11 is the view of FIG. 5, with the striker in the upper rest position and the safety lock in the engaged position under the striker.

FIG. 12 is the view of FIG. 4, with the base spaced away from the body and the safety lock in the engaged position of FIG. 11.

FIG. 13 is the view of FIG. 6, with the striker and safety lock in respective upper and engaged positions.

FIG. 14 is a side, slight top, perspective internal view of a left housing of the stapler.

FIG. 15 is a side elevation of a handle-to-lever link.

FIG. 16 is a top, side perspective view of the link of FIG. 15.

FIG. 17 is a perspective view of a sub-assembly of a power spring and cage, with further assembly elements of a lever, link, reset spring, striker, latch, latch holder, and safety lock.

FIG. 18 is an exploded perspective top view of the assembly of the power spring, cage and lever, with the power spring in a flat configuration.

FIG. 19 is the exploded assembly of FIG. 15, in a more side view direction.

FIG. 20 is the assembly of FIG. 17, in the upper rest position of FIG. 1.

FIG. 21 is a rear, side perspective view of a latch.

FIG. 22 is a bottom, side, perspective internal view of a handle.

### DETAILED DESCRIPTION OF THE PREFERRED EMBODIMENTS

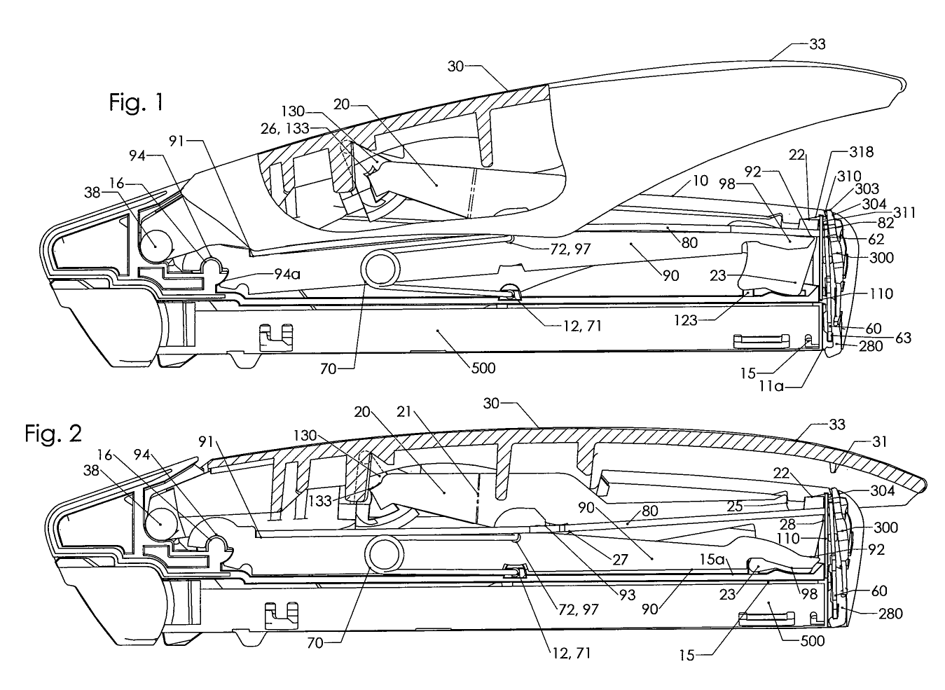

FIGS. 1 to 3 show a preferred embodiment stapler of the present invention in three representative positions of its operating cycle. FIG. 1 is a rest position, with handle 30 pivoted to a farthest position above housing 10. Track 500 fits within track chamber 15 of housing 10. Staples (not shown) are held upon track 500 and fed toward the front of chamber 15 to be positioned under striker 110. Lever 20, power spring 80, striker 110, and cage 90 are in respective upper-most positions. Striker 110 is above track chamber 15. Power spring 80 is preferably an elongated flat spring. The spring 80 includes two elongated openings 81 separated by web 84 (FIG. 19). Power spring 80 is pre-loaded by confinement in cage 90, as discussed later. Striker 110 fits slidably in slot 11 of housing 10, movable toward slot exit 11a.

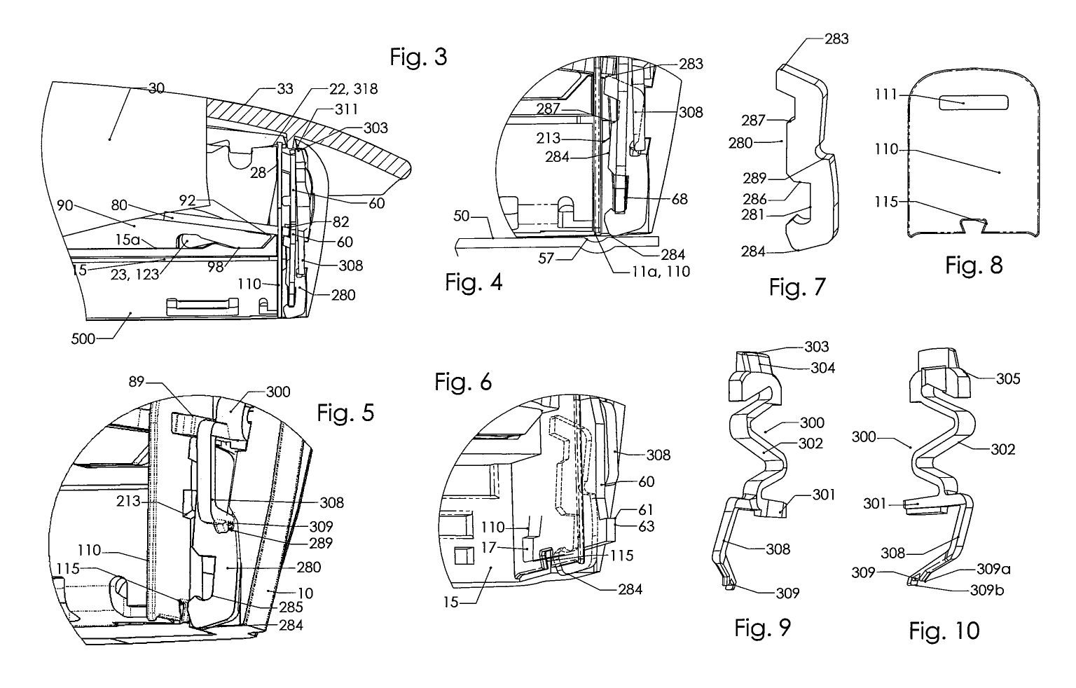

In FIG. 2, handle 30 is partly depressed toward housing 10. Power spring 80 is deflected downward by lever 20 near the spring length center to store energy. Cage 90 and power spring 80, defining a spring/cage sub-assembly, rotate at pivot 94 about hinge post 16 near the rear of housing 10. In FIG. 2, cage 90 is near, but not yet at, its lowest most position. Upward facing cage edge 94a engages an underside feature of the hinge post to confine the cage in an upward direction. Compare FIG. 2 and FIG. 3 lower front edge 98 of the cage. Cage 90 is spaced above ceiling rib 15a of chamber 15 in FIG. 2. In FIG. 3, the space is closed and cage 90 is immediately adjacent to the ceiling rib. When the cage and related parts reach the lowest position of FIG. 3, spring end 82 is suddenly released, as discussed later, to allow power spring 80 to force striker 110 to its lowest position. Optionally, a rear element of power spring 80 may engage the housing near post 16 (not shown); then the assembly rotates about an element of the spring rather than about an end of the cage.

Between the upper position of FIG. 1 and the lower most position of FIG. 3, including the lower intermediate position of FIG. 2, cage 90 is effectively loose in the assembly, pivoting about hinge post 16 and not confining power spring 80. It is held from rattling by its fit at notch 93 upon web 84 of power spring 80 (see also FIG. 19). In FIG. 3, striker 110 has been released to a lowest position in front of track 500. Cage 90 and power spring 80 are in respective lowest positions.

In FIGS. 1 and 3, a subassembly of cage 90 and power spring 80 is in different positions but in the same rest configuration. The cage/spring subassembly may be assembled off-line or separately, and installed later into the main assembly. The spring is pre-stressed against cage 90, and sits loosely in housing 10 during assembly, allowing a low effort process for assembly line workers or automation. This contrasts with a power spring that is pre-stressed against a further element of the stapler. Such an externally stressed spring must be forced into the assembly. For example, a power spring that is pre-stressed against the housing or a further linking lever would require uncomfortable, manual deflection of the spring by the assembly line workers, or use of high force output automation.

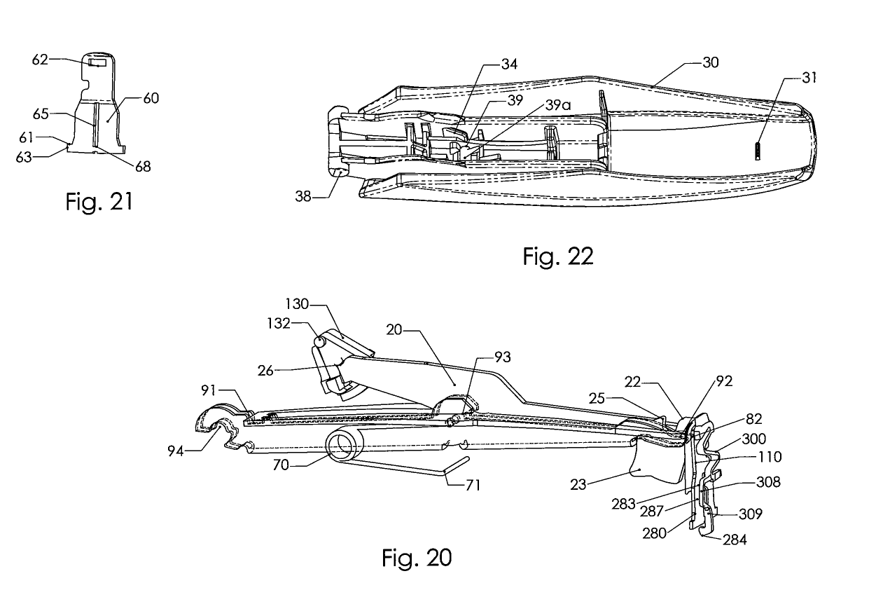

FIG. 1 corresponds to the simplified view of the upper position in FIG. 20. Power spring 80 is in the pre-stressed rest configuration. In FIG. 2, the spring is deflected and energized from this pre-stressed rest configuration. FIG. 3 corresponds to the view of the lower position in FIG. 17. In a free position of the power spring (not shown), the spring is arced to a largest extent, with ends lower and center higher. In the spring/cage rest configuration the power spring is pre-stressed to force the ends up and center down to form the arc as shown in FIGS. 1, 3, 17, and 20. For clarity power spring 80 is in a flat configuration in the exploded views of FIGS. 18 and 19. Using a pre-stressed configuration for the power spring means that the relative change of spring force between the rest configuration, FIG. 1, and the pressed configuration, FIG. 2, is minimized compared with a non pre-stressed spring wherein the initial rest force is zero. The pre-stressed spring combined with varying handle leverage described later provide a relatively constant handle force through the stroke.

Power spring 80 is preferably held at three locations by cage 90. At the front, cage tip 92 supports spring end 82 from below (see FIGS. 19, 20). At the rear, notch 91 supports a rear end of the spring from below. In the center at spring web 84, hook 93 presses the power spring from above. Hook 93 and optionally a front portion of the cage fit within elongated openings 81 (see FIG. 17). Cage 90 includes a U-channel section, wherein lever 20 fits within the channel. The channel is open at the front bottom to allow lever guide tab 23 to pass below. Forward slot 81 terminates at narrow end 85 through which passes guide tab 23. Cage tip 92 presses upward immediately to each side of narrow slot end 85. The assembly as described is nested together to provide a very compact mechanism, with one or both of the lever and cage being nested within slot 81 of power spring 80, and the lever is further nested at least partially within the “U” channel of the cage. The nesting is a great advantage since it allows a spring actuated desktop stapler to be overall very compact in the vertical and horizontal directions.

Notch 91 of cage 90 includes ribs or equivalent structures to hold power spring 80 in position lengthwise upon cage 90. Optionally, a notch or rib of the cage can engage the power spring at web 84 to hold the lengthwise position. Preferably, the power spring is not held at two separate lengthwise locations, as flexing of the spring would cause stress between two such fixed attaching points. Cage 90 is in turn held pivotally in a lengthwise position as part of the spring/cage subassembly on housing 10 at hinge post 16. In this manner, spring end 82 is accurately held in position relative to striker 110 in the rest position of FIG. 1. This is helpful for the release action described later.

Lever 20 is preferably made from a flat metal form. This allows the lever to easily fit within the channel of cage 90 and be of low cost. Lever 20 is pivotably engaged to housing 10 at laterally extending tab 22. Tab 22 forms an asymmetric feature of the lever, engaging primarily one side of housing 10; this is the left side as illustrated in the figures. The force from tab 22 may be linked to the right, or opposite housing side through a weld or other attachment means near recess 318, whereby both sides may provide support to tab 22. Tab 22 presses upward upon a ceiling or rib of housing at a front of the housing, in recess 318 (see FIGS. 1, 14 as illustrated). Tab 22 presses near an uppermost position of housing 10 such that in the handle lowest position of FIG. 3, the handle is immediately adjacent to recess 318 or other surface upon which tab 22 presses. Tab 22 includes a large surface to engage the housing, so there is minimal wear at the recess as the lever pivots. In addition to the above described vertical force by lever 20, there are also horizontal or lengthwise forces acting upon the lever. Such force is light during a reset cycle, as striker 110 rises to the initial rest position, but larger through parts of the handle pressing stroke as the power spring is energized.

As handle 30 is pressed through link 130, during an energizing stroke of the stapler, lever 20 is forced forward because of the angular orientation of the mounting of link 130, as discussed later regarding leverage. Link 130 imparts a forward force vector upon lever 20 through the upper positions of the handle stroke. It is therefore preferred that lever 20 is well supported against moving toward striker 110. There may be limited housing material for this purpose at tab 22, specifically in the preferred compact design striker 110 may, as illustrated, occupy the space immediately in front of lever 20 and tab 22 that is best used for bearing forward forces of the lever. In the preferred embodiment lever 20, at or near tab 22, abuts and presses striker 110 through the operating stroke of handle 30, up to the release point of the striker. Striker 110 is substantially stationary during this action, and is well supported in slot 11 (FIG. 14) so it creates an effective, sturdy bearing surface for the lever. At the lower position of FIGS. 2 and 3, link 130 rotates relative to handle 30 and lever 20 to be near vertical, the link therefore presses substantially vertically upon lever 20. The bearing surface of striker becomes less important. In FIG. 3, edge 28 of the lever is pressing striker 110, but gently since FIG. 3 is the lower position. Upon release of the striker, the force applied by the lever quickly decreases to near zero as the striker moves suddenly downward to the position of FIG. 3. Therefore, lever 20 does not require the sturdy support of striker 110 as a front bearing at or near the release point. To position lever 20 in this low forward force position, edge 25 of lever 20 presses a rib at the rear of recess 318 (FIGS. 2 and 14). This engagement operates through the reset cycle as the stapler moves from the position of FIG. 3 back to that of FIG. 1.

Optionally, lever 20 may press upon the forward edge of front slot 81, behind front edge 82. This pressing may be instead of or in addition to the striker pressing described above. This forward force is transmitted through the power spring to rear notch 91, and finally through pivot 94 to hinge post 16 of the housing. As with the striker, pivot 94 provides a substantial bearing surface. As with the striker, the front edge of power spring 80 remains substantially stationary as handle 30 is pressed downward, and there is minimal forward bias here at the release point.

Guide tab 23 extends downward to near ceiling 15a of track chamber 15. As seen in FIGS. 1, 3, and 14, ribs 123 guides tab 23 to maintain lever 20 on-center within housing 10. Cage 90 includes an opening in this area (FIG. 3) to allow cage 90 to clear rib 123. The right housing (not shown) includes a similar rib. Cage 90 extends up through spring opening 81 here to maintain a sturdy section to the cage. Cage 90 includes another cut-out at the bottom, near the length center coinciding with reset spring hole 97, to clear lower spring boss 12. Hook 93 preferably extends upward at this same location to maintain a sturdy section for cage 90.

Lever 20 presses near web 84 of power spring 80 at pressing edge 24 near a center of the lever length. To minimize sliding at this interface hinge post 16, edge 24, and tab 22 are substantially collinear in housing 10 from the upper to the lower positions (FIGS. 1 and 2). Being aligned, these rotation points maintain near constant relative distance, and therefore will operate nearly entirely by pivoting and not by sliding. Lever 20 preferably includes notch 27 with a rib extending under the power spring whereby the lever can pull up upon power spring 80. As illustrated, notch 27 engages web 84 of the power spring 80.

As further illustrated, the lever engages power spring 80 directly at web 84 or other equivalent nearby area. Optionally, one or both of lever edge 24 and pull-up notch 27 may engage the power spring through the cage. For example, the area of hook 93 may include a notch or tab to link to edge 24 and/or notch 27 or equivalent features of lever 20 (not shown). If hook 93 or equivalent feature fits well to power spring 80 then connecting the handle to the power spring through cage 90 will provide an equivalent result to a more direct connection to the power spring.

For best efficiency in a compact package, cage 90 should preferably move from an upper most possible position (FIG. 1) to a lowest possible position adjacent to ceiling 15a (FIG. 3). In this manner no space is wasted. Cage 90 also should be rigid as discussed above. Otherwise, in the rest configuration of FIGS. 1 and 3, cage 90 deflects along with the power spring. The energy to deflect the cage is absorbed by the cage and wasted in FIG. 3 as power spring 80 resumes its load upon the cage. With the U-channel section and maximized section along its length, cage 90 has negligible deflection in the assembly.

Reset spring 70 fits under power spring 80 (see FIG. 2). The reset spring includes upper leg 72 and lower leg 71 fitting respective hole 97 in the cage and boss 12 in housing 10. Reset spring 70 preferably includes a minimal shape change as it moves from the upper position of FIG. 1 to the lower position of FIG. 2 and similar lower most position of FIG. 3 (not shown). Therefore, with an adequate pre-load, as defined by a large free angle between the legs, the reset spring provides a near constant reset bias to the assembly. This advantageously avoids any excess force at the lower position that otherwise occurs if the reset has a large shape change.

Link 130 provides a low friction connection between the rear end of lever 20 and handle 30. The length of lever 20 and related position of link 130 along handle 30 determine the leverage of handle 30 upon power spring 80. A longer lever with more rearward mounting to handle 30 generally enables more leverage; the handle moves a greater handle travel distance and therefore requires lower user input force acting on handle pressing area 33. The stapler thus requires lower input effort by the user, and hence those who cannot generate much finger pressure such as the elderly and children can still easily operate the stapler.

As power spring 80 is deflected, the reaction force from the spring increases. It is desirable to minimize this effect at the handle so the peak force at the end of the stroke is not excessive. For this purpose, the leverage of handle 30 upon power spring 80 preferably varies through the pressing stroke to maintain a more constant pressing force for all handle positions. Preferably a low initial leverage (high spring motion relative to handle) becomes higher (low spring motion relative to handle) toward the end of the stroke. The link 130 allows this varying leverage through a changing angular relationship between handle 30 and power spring 80, as discussed above regarding the lever forces at tab 22. In the initial rest position of FIG. 1, link 130 angles downward and forward from the handle. Toward the lower position, as in FIG. 2, link 130 is more nearly vertical. This angle change provides the desired varying leverage through a cam-like action; the handle at link 130 moves forward relative to the lower link mount at lever rear end 26 as both initially move downward. Link 130 thus rotates and becomes more vertical to cause the handle and lever end 26 to separate from each other. This wedging action between the handle and lever (FIG. 1) enhances the downward motion of the lever until the link approaches vertical (FIG. 2). In FIG. 2, the handle and lever end 26 move downward directly in tandem.

The result of this action is the handle initially moves the lever disproportionately fast, and the relative motion becomes proportionate as the stroke proceeds. Hence, the leverage increases. The spring force increases through the stroke, so increasing leverage counteracts the increasing spring force, resulting in the input force operating the handle stays near constant. Again, this benefits the users who may have weak fingers and cannot apply great pressure to comfortably fire the stapler.

In the illustrated embodiment, housing 10 presses down upon a left side of lever 20 by lever tab 22. Power spring 80 presses upward upon lever 20 at a center of a width, or centerline, of lever 20, at edge 24. This centerline is normally also a centerline of the body generally defined by housing 10. These two forces cause a twisting moment on the lever, the top of the lever biased into the page in FIGS. 1 and 2. The third pressing location, at link 130, should counteract this moment to minimize friction. Otherwise, lever 20 must be contained by force within housing 10. For example, tab guide 23 would slide firmly against rib 123 of the right housing (not shown) rather than just be guided by the rib. Accordingly, lever 20 preferably includes offset bend 21 to the opposite side from tab 22. Rear end 26 preferably includes a rear tab that extends back across the centerline, into the page of the figures. Link 130 includes surface 133 to engage rear end 26. Surface 133 thereby presses lever 20 on the offset portion, opposite the centerline from front tab 22. With proper geometry, these forces cancel each other so lever 20 exhibits no twisting moment, minimizing a malfunction of the mechanism. Surface 134 opposite 133 provides a lift surface to pull up on lever 20 at the tab of rear end 26 in a tensile connection. The rear end tab thereby pivotably fits into an opening or recess of link 130.

Accordingly, the present invention spring energized stapler mechanism is very efficient, and requires minimal component travel distances resulting in both a low user applied force with reliable, repeatable performance. For example, based on empirical observations, a peak handle force of less than about 6.5 lbs., and preferably less than about 6.0 lbs., at pressing area 33 provides effective fastening by stapling of more than 20 sheets of 20 pound paper using standard 26/6 staples.

Link 130 is pivotably attached to handle 30 at recess 39 (FIG. 22). Link 130 is preferably snap fitted into its handle position whereby the link can connect handle 30 to lever 20 in tension. For assembly, handle 30 may be installed as a last component. Both left and right (not shown) housings are fitted to the internal parts including link 130. Handle 30 is installed into opening 19 (FIG. 14) and moved rearward until bosses 38 align with recesses 13 of housing 10. The handle moves over link 130 until the link is aligned with recess 39 of the handle. Boss 132 then snaps into the recess, and link 130 is pivotably held to the handle in pressing and in tension. An elongated groove 39a or equivalent structure at recess 39 fits link 135 as a bearing interface.

Link 130 includes resilient arm 135 to retain boss 132 in recess 39. Preferably, the single arm and boss form an asymmetric design for link 130 for simplicity. Arm 135 biases boss into recess 39 with enough force to provide for the required tensile action. For installation of the handle, ramp 34 (FIG. 22) causes resilient arm 135 to deflect to allow boss 132 to clear the rib that includes recess 39.

Optionally, handle 30 may be directly connected to power spring 80 and/or cage 90, without link 130 or other movable link. There can then be some sliding at the interface of handle 30 and lever 20, so the connection may be through a low friction material such as Delrin, Teflon, or the like.

FIGS. 1 to 3 show a latch holder 300 and latch 60, respectively, that work in conjunction to release striker 110 to fire the stapler. Such a release mechanism holds striker 110 and spring front end 82 in the upper rest position until a predetermined release point. The release mechanism may operate in a similar manner to that disclosed in co-pending U.S. patent application titled “High Start Spring Energized Stapler,” filed on Jan. 20, 2006, Ser. No. 11/343,343, by Joel S. Marks, whose entire contents are hereby incorporated by reference.

In the view of FIG. 1, a rest condition of the release mechanism is shown. Latch holder 300 includes resilient section 302 between mounting post 301 and distal end 303. Specifically, latch holder 300 includes distal end 303, and a zigzag resilient portion 302 connects distal end 303 to lower mount 301 (FIGS. 9, 10). Lower mount 301 engages slot 18 of housing 10 (see FIG. 14). Latch holder 300 is at least slightly pivotally attached at lower mount 301. Zigzag resilient portion 302 causes distal end 303 to be biased upward in FIG. 1. Upward movement of distal end 303 is limited by shoulders 305 or other structure of latch holder 300 pressing against housing 10. Distal end 303 protrudes through opening 310 in housing 10, and when the user presses down on handle 30, triggering rib 31 underneath the handle (FIG. 3) engages and pushes on distal end 303 to begin a sequence of events that eventually releases striker 110 and fires the stapler.

Spring end 82 extends through slot 111 of striker 110 and at least partially into slot 62 (FIG. 21) of latch 60. Spring end 82 should be positioned accurately relative to the latch for reliable release action. Latch holder 300 is constrained within opening 310 and in turn prevents latch 60 from moving forward. Latch 60 therefore selectively immobilizes striker 110 and limits downward motion of striker 110 as power spring end 82 presses down within slot 62 as power spring 82 is loaded by the user pressing down on handle 30. Power spring end 82 thus remains stationary at each end until its release as handle 30 is pressed. Latch 60 is preferably made from hardened steel.

As handle 30 is pressed, the stapler assumes the pre-release configuration of FIG. 2. It is seen that the front area of power spring 80 is angled upward in FIG. 2. Therefore, power spring end 82 engages latch slot 62 at a non-perpendicular angle, thereby pressing downward and forward on latch 60. Latch 60 under this power spring pressure presses forward against latch holder 300. This is a pre-release position, not shown, where handle 30 is preferably near to its closest possible position toward housing 10 as in FIG. 3, but with the upper power spring pre-release position of FIG. 2. Power spring center near web 84 is deflected or bent downward while the front and rear ends remain in the initial upper rest position. Cage 90 rotates downward.

Optionally, power spring end 82 may include a local upward bend (not shown) to increase the forward pressing force vector on latch 60. The shape of the bend may be selected to optimize the release action, providing just enough forward bias to reliably move latch 60 forward while not so much that other components such as latch holder 300 or housing 10 are distorted by excess biasing force from power spring 80.

In FIG. 3, as a result of the downward pressure applied by the user on handle 30, triggering rib 31 of handle 30 has moved latch holder 300 downward. Triggering rib 31 of handle 30 has pushed distal end 303 of latch holder 300 below corner 311 of housing 10, allowing latch holder 300 to move forward under the forward bias of power spring 80 as transmitted through latch 60 which has also tilted forward. Once the top end of latch 60 tilts forward, slot 62 of latch 60 no longer confines spring end 82, allowing spring end 82 to freely accelerate downward under spring bias to fire the stapler. Since the spring end is captured within slot 111 of striker 110, the downward motion of spring end 82 accelerates striker 110 in the same direction.

After its release, striker 110 rapidly moves downward to eject a staple disposed on staple track 500 (not shown) by impact blow, and handle 30 remains in the lowered position. After striker release, the power spring/cage subassembly resumes its rest shape of as shown in FIG. 3, but in a lower angular position relative to FIG. 1. After release and ejecting a staple, striker 110 is in its lowest position in front of track 500.

As discussed earlier, latch 60 is pressed forward against latch holder 300 under bias from the angled spring end 82. As seen in FIGS. 1 and 2, the geometry of angled portion 304, also see FIG. 9, pressing slightly upward on corner 311 of housing 10 creates a slight downward tendency on latch holder 300, just less than the friction holding the system in place. This reduces the force required from triggering rib 31 to press latch holder 300 downward to fire the stapler. Latch holder 300 is preferably made from a low friction material such as Delrin, acetal, nylon, Teflon, greased metal, or other low friction materials. These types of low friction materials help minimize wear between latch holder 300 and housing 10 at corner 311 and improves the life of the stapler. A low friction interface also helps ensure the release action is reproducible and reliable.

Latch 60 is pivotably attached to housing 10 by latch tab 63 within recess 17 (see FIG. 6). This attachment is preferably near a lowest position in housing 10 in front of track 500. Recess 17 includes engagement with the upper edge of pivot tabs 61, so latch 60 is held from shifting upward. This feature is helpful during reset action as spring end 82 slides and arcs upward along latch 60 as the power spring/cage assembly pivots about post 16.

After striker release, spring end 82 contacts latch 60 in the position shown in FIG. 3. Latch 60 is thus held in its forward position. Downward pressure on handle 30 is then removed by the user so that handle 30 is biased upward in a reset action toward the handle rest position of FIG. 1. Striker 110 and the power spring/cage subassembly move upward with handle 30 under the bias of reset spring 70. Consequently, latch holder 300 is also held in its forward position. Spring end 82 moves in an arc about hinge post 16 as discussed above. During reset, latch 60 should remain in the forward-most position so that it does yet resume the latch rearward pre-release position in FIG. 1, behind release opening 310. The forward-most latch position holds latch holder 300 out of the way. If latch 60 is allowed to move to the rear position, latch 60 becomes locked in the rear, rest position by latch holder 300 entering release opening 310. Latch 60 would then block or obstruct the desired movement of spring end 82, preventing it from moving up and into slot 62 of latch 60 to complete the reset action.

To ensure that latch 60 remains forward during reset, latch pivot tabs 63 and recesses 17 receiving those pivot tabs are preferably located as low as possible in housing 10 near the bottom of track chamber 15. The distance or torque arm as measured between pivot tabs 63 and spring end 82 in the after-release position of FIG. 3 is maximized to allow spring end 82 to apply useful holding torque on latch 60. This ensures that latch 60 remains forward during reset.

The preferred embodiment safety lock 280 is fitted slidably and pivotably at a front of the stapler. It normally extends under striker 110 to lock the striker in the upper rest position (FIG. 12). Preferably, a two step process moves the lock. A first step is primarily by rotation and provides a fast disengagement. A second step is primarily by translation and allows for additional motion without further disengagement. The purpose of the two step process is to allow for imperfect engagement with a surface such as papers. If an obstruction such as a fold or other installed staple (not shown) keeps the housing slightly spaced away from the page at exit area 11a (FIGS. 4 and 12) the safety should still operate to disengage to allow a striker 110 to install a staple.

Therefore, the safety immediately moves to disengage while the housing may still be spaced from the paper, and the safety continues to retract inward to allow for the normal zero spaced condition. Lower tip 284 extends downward out from housing 10 to its lowest relative position, as defined by a dimension labeled “H.” Dimension “H” may describe the actual vertical motion of the safety lock, or it may describe the extended distance of FIG. 12 relative to the bottom the body or housing 10 at striker slot exit 11a. The maximum extension of safety lock 280, as defined by dimension “H” in FIG. 12, may range preferably from about 0.040 to 0.090 inch inclusive of the outer limits, with the extension more preferably ranging between about 0.050 to 0.070 inch inclusive of the outer limits. Based on empirical observations, such extension ranges allow for typical obstructions described above while not interfering too much with the space into which papers are inserted.

The first motion is shown in FIG. 12. The initial position is shown with safety lock 280 in solid lines. Rib 68 (FIGS. 12 and 21) provides a bearing and pivot surface for safety lock 280. Edge 287 of the lock moves against cam 213 of housing 10 or equivalent cam surface (see also FIG. 5, as the lock pivots). The lock pivots along rib 68, guided by the cam, at rear edge 281 in the first motion of FIG. 12. At the end of the first motion safety lock 280 is in the position of the dashed lines of FIG. 12, at which point it reaches a limit of its pivoting motion. Lower tip 284′ is in the indicated position at this point. Lock tip 283 is clear of striker 110 at 283′, and the striker can move downward if it is released from latch 60 in normal operation. The lock is then free to begin the second motion upward if required.

In FIG. 4, safety lock 280 is in its upper most position at the end of the second motion. Rear edge 284 has slid along the front of cam 213 until base 50 has pressed the lock to its upper most retracted position. This comprises the second, primarily translational step of the safety lock motion. Anvil 57 provides a guide to clinch staples behind papers to be fastened. Tip 284 presses adjacent to, but not within, the path of striker 110 and anvil 57.

Latch holder 300 includes bias arm 308 (see FIGS. 9 and 10). Bias arm 308 includes segment 309, defined by left side rib 309a and right side rib 309b. Safety lock 280 is preferably a simple flat metal form. The left and right ribs 309a,b partially surround the lock to retain the distal end of bias arm 309 about the metal form of the lock. Segment 309 presses notch 289 of safety lock 280 (FIGS. 7 and 12) in a direction down and rearward, to the left in FIG. 12. Lock tip 283 is thereby biased to be under striker 110 in the raised housing position of FIG. 12. Bias arm 308 provides both the rearward bias for the first rotational operating step, and the vertical bias for the second translating operational step. The bias arm should be resilient enough allow for the full operating motion of safety lock 280. Bias arm 308 is preferably molded integrally as a same part as latch holder 300 for simplicity, but may optionally be a separate component of the stapler. The latch holder therefore preferably includes two resilient actions, zigzag resilient portion 302 to operate distal end 303 to hold the latch, and bias arm 308 to operate safety lock 280.

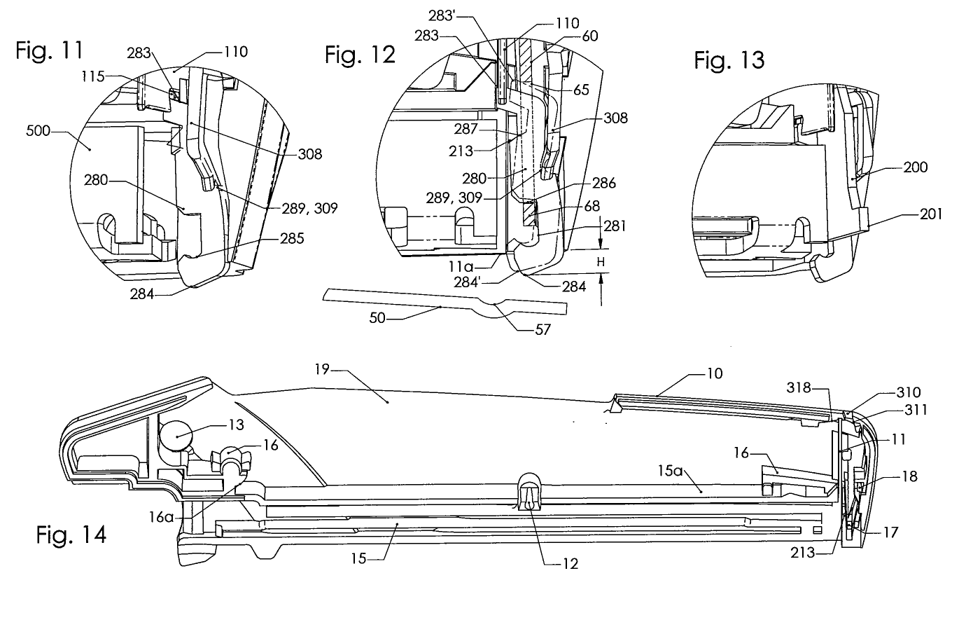

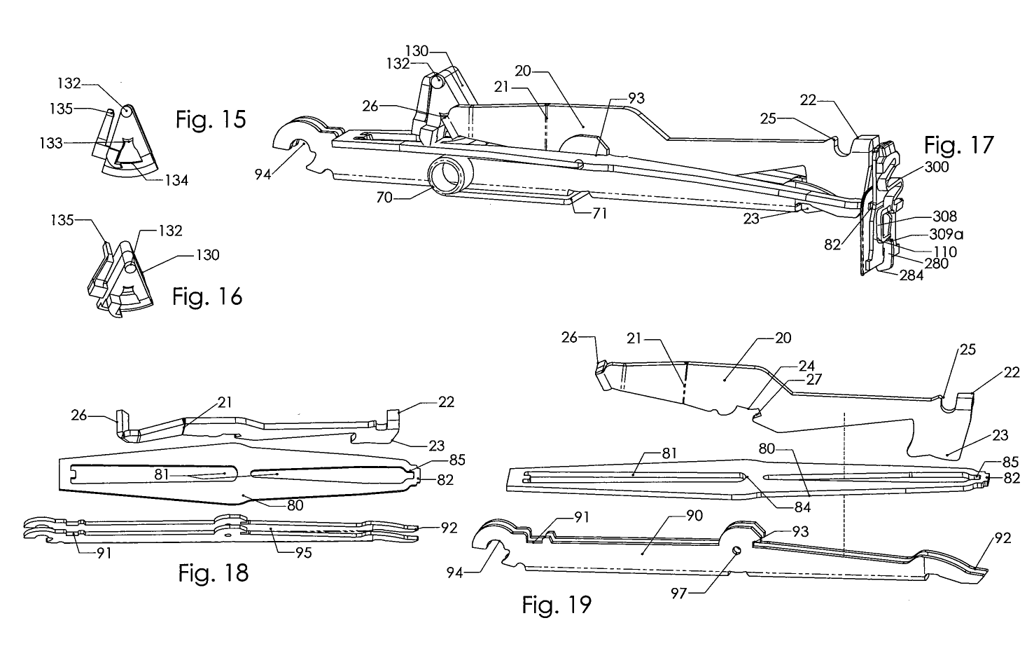

Safety lock 280 is preferably as long as possible within the constraints of the stapler to allow effective motion at tip 283 during rotation and reasonable control of the action of the lock. The bottom edge of the striker may be continuous near the safety lock, such that tip 283 is entirely below the striker. However, it is preferable to nest the striker over the lock to minimize the overall height of the assembly and maintain the compact height of the body. Striker 110 includes notch 115 (see FIGS. 8 and 11). Lock tip 283 fits or nests into the notch to engage the upper edge of notch 115 during active use. Notch 115 preferably includes angled sides as illustrated, with the lower notch end being narrower than the upper portion. A narrow bottom notch area prevents an upward lump or distortion in a staple wire at the notch as the striker presses the staple into position. However, a narrow notch requires relatively precise side alignment of the safety lock to ensure that tip 283 can enter the notch in the rest position. Therefore, notch 115 is wide at its upper end; as striker 110 rises during the reset action tip 283 encounters this wide area to provide a generous guide into the notch.

From the foregoing detailed description, it should be evident that there are a number of changes, adaptations and modifications of the present invention that come within the province of those skilled in the art. However, it is intended that all such variations not departing from the spirit of the invention be considered as within the scope thereof as limited solely by the following claims.

What is claimed is:

1. A high-start spring-actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically within the body between an initial rest position above the track and a lower-most position in front of the track;
a power spring disposed within the body and linked to the striker to bias the striker into the lower-most position;
a lever pivotably attached to the body, wherein the lever links the handle to the power spring whereby pressing the handle causes the power spring via the lever to deflect and store energy, the lever including a substantially sheet metal form having a bent front tab at a front end, the front tab being bent toward a side of the stapling device to form an asymmetric feature of the stapling device; and
the front tab pressing upward within the housing at an upper, front of the housing.

2. The stapling device of claim 1, wherein the power spring includes an elongated slot, and a guide tab extends downward through the slot to a location between guide ribs of the stapling device.

3. The stapling device of claim 1, wherein the lever includes a bend along its length, and a rear end of the lever is on an opposite side of a centerline of the stapling device from the front tab.

4. The stapling device of claim 3, wherein the rear end of the lever includes a rear tab, the handle presses the rear tab, and the rear tab extends across a centerline of the lever to a same side of the lever as the front tab.

5. A high-start spring-actuated stapling device, comprising:
a body;
a track along a bottom of the body to guide staples toward a front of the stapling device;
a handle pivotably attached to the body wherein the handle includes an initial rest position where the handle is pivoted to a farthest position away from the body, and a pre-release position where the handle is pivoted toward the body;
a striker movable vertically within the body between an initial position above the track and a lower-most position in front of the track;
a power spring disposed within the body linked to the striker, wherein the power spring is deflected and energized as the handle moves from the farthest position to the pre-release position;
a lever linking the handle to the power spring;
a power spring/cage subassembly formed by a cage at least partially confining the power spring wherein the power spring is preloaded in a rest position, and wherein the cage is separately movable from the handle; and
the cage having a U-channel section, wherein the lever is co-extensive with the cage, and the lever is at least partially nested within the U-channel section.

6. The stapling device of claim 5, wherein the power spring includes an elongated slot, and the cage is at least partially nested within the slot of the power spring.

7. The stapling device of claim 6, wherein the cage includes a hook, the hook extending through the slot, and the hook confining a center of a length of the power spring.

8. The stapling device of claim 5, wherein the lever includes a guide tab, and the guide tab extends through an opening at a front bottom of the channel of the cage, and the guide tab moves between guide ribs of the stapling device.

9. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body, and a pre-release position where the handle is pivoted toward the body;
a striker movable vertically within the body between an initial position above the track and a lower-most position in front of the track;
a power spring disposed within the body linked to the striker, wherein the power spring is deflected and energized as the handle moves from the farthest position to the pre-release position;
a lever linking the handle to the power spring; and
a power spring/cage subassembly formed by a cage at least partially confining the power spring wherein the power spring is preloaded in a rest position, and wherein the cage is separately movable from the handle, the power spring cage subassembly is pivotably attached near a rear of the subassembly, and a front end of the cage moves vertically a distance within the housing between an initial upper rest position and a lower most position, the distance being about 0.30″ to 0.5″ inclusive.

10. The stapling device of claim 9, wherein the distance is about 0.35″ to 0.4″ inclusive.

11. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body, and a pre-release position where the handle is pivoted toward the body;
a striker movable vertically within the body between an initial position above the track and a lower-most position in front of the track;
a power spring disposed within the body and linked to the striker, wherein the power spring is deflected and energized as the handle moves from the farthest position to the pre-release position; and
the housing, at a location of the striker, being equal or less than about 1.1″ tall between a top of the housing and a bottom of the housing.

12. The stapling device of claim 11, wherein the handle includes a pressing area toward a front of the handle, and at the pressing area the handle moves between about 0.8″ to 1.1 inclusive toward the housing from the initial rest position to the pre-release position.

13. The stapling device of claim 12, wherein the handle at the pressing area moves about 0.8″ to 1″ inclusive.

14. The stapling device of claim 12, wherein a ratio between motion at the front of the handle to motion at the front of the cage ranges from about 1.6 to 3.7 inclusive.

15. The stapling device of claim 13, wherein a ratio between motion at the front of the handle to motion at the front of the cage ranges from about 2.2 to 2.9 inclusive.

16. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body, and a pre-release position where the handle is pivoted toward the body;
the handle includes a pressing area toward a front of the handle;
a striker movable vertically within the body between an initial position above the track and a lower-most position in front of the track;
a power spring disposed within the body and linked to the striker, wherein the power spring is deflected and energized as the handle moves from the farthest position to the pre-release position; and
at the handle pressing area, a pressing force of less than about 6.5 lbs provides fastening by stapling of more than 20 pages of 20 pound paper using standard 26/6 staples.

17. The stapling device of claim 16, wherein the handle force is less than about 6.0 lbs.

18. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body, and a pre-release position where the handle is pivoted toward the body;
a striker movable vertically within the body between an initial position above the track and a lower-most position in front of the track;
a power spring disposed within the body and linked to the striker, wherein the power spring is deflected and energized as the handle moves from the farthest position to the pre-release position; and
the handle includes a pressing area toward a front of the handle, and at the pressing area the handle moves between about 0.8″ to 1.1 inclusive toward the housing from the initial rest position to the pre-release position.

19. The stapling device of claim 18, wherein the handle at the pressing area moves about 0.8″ to 1″ inclusive.

20. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically within the body between an initial rest position above the track and a lower-most position in front of the track;
a power spring disposed within the body and linked to the striker to bias the striker into the lower-most position; and
a lever pivotably attached to the body, wherein the lever links the handle to the power spring, pressing the handle causes the power spring via the lever to deflect and store energy, the lever pressing forward against the striker as the handle is pressed toward the pre-release position from the rest position.

21. The stapling device of claim 20, wherein the lever presses forward on the power spring at a front of the power spring.

22. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically within the body between an initial rest position above the track and a lower-most position in front of the track;
a power spring disposed within the body and linked to the striker to bias the striker into the lower-most position; and
a lever pivotably attached to the body, wherein the lever links the handle to the power spring, pressing the handle causes the power spring via the lever to deflect and store energy, the lever pressing forward against the power spring at a front of the power spring as the handle is pressed toward the pre-release position from the rest position.

23. The stapling device of claim 22, wherein the lever presses forward against the striker.

24. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically along a path within the body between an initial rest position above the track and a lower-most position in front of the track;
a power spring disposed within the body and linked to the striker to bias the striker into the lower-most position;
a safety lock movably attached at a bottom front of the body, adjacent to the striker path, the safety normally extending under the striker in the striker upper rest position to restrict motion of the striker; and
the safety lock movable a distance “H” between an extended position out from a bottom of the body and a retracted position within the body, wherein distance “H” is between about 0.04 to 0.09 inclusive.

25. The stapling device of claim 24, wherein distance “H” is between about 0.050″ to 0.070″ inclusive.

26. The stapling device of claim 24, wherein the striker is held in the rest position by a latch, and the latch includes a rib adjacent to the safety lock, the rib providing a bearing surface to support the lock.

27. The stapling device of claim 24, wherein the safety lock moves in at least a two step process, a first step being primarily be rotation of the safety lock, and a second step being primarily by translation of the safety lock.

28. The stapling device of claim 24, wherein a latch holds the striker in the initial rest position, and a latch holder further holds the latch, and the latch holder includes two resilient elements, a first resilient element to operate one end of the latch holder to hold the latch, and a second resilient element to operate the safety lock.

29. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically along a path within the body between an initial rest position above the track and a lower-most position in front of the track;
a power spring disposed within the body and linked to the striker to bias the striker into the lower-most position;
a safety lock movably attached at a bottom front of the body, adjacent to the striker path, the safety lock normally extending under the striker in the striker upper rest position to restrict motion of the striker; and
a notch disposed along a bottom edge of the striker, wherein a tip of the safety lock extends into the notch in the striker upper rest position.

30. The stapling device of claim 29, wherein the notch includes angled sides, a bottom of the notch being narrower than a top of the notch.

31. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted toward the body;
a striker movable vertically within the body between an initial rest position above the track and a lower-most position in front of the track;
a power spring disposed within the body and linked to the striker to bias the striker into the lower-most position;
a lever pivotably attached to the body at a front of the body, wherein a rear end of the lever links to the handle, and the lever presses the power spring from above at a pressing edge near a center of the lever whereby pressing the handle causes the power spring via the lever to deflect and store energy, the lever comprising substantially a sheet metal form including a notch near the pressing edge, a rib of the notch extending below the power spring; and
the lever includes a tensile connection to the power spring whereby the lever pulls the power spring and striker upward.

32. The stapling device of claim 31, wherein the rear end of the lever links to the handle through a pivotable link, the link fitting pivotably to the lever rear end, and the link pivotably fitted to the handle.

33. The stapling device of claim 32, wherein the link includes a snap fit into a recess of the handle, and the link provides a tensile connection between the handle and the lever.

34. A spring actuated stapling device, comprising:
a body;
a track along a bottom of the body to guide staples toward a front of the stapling device;
a handle pivotably attached to the body wherein the handle includes an initial rest position where the handle is pivoted to a farthest position away from the body and a pre-release position where the handle is pivoted to be adjacent to the body;
a striker movable vertically within the body between an initial rest position above the track and a lower-most position in front of the track;
a power spring disposed within the body and linked to the striker to bias the striker into the lower-most position;
a lever pivotably attached, at a lever front end, to the body at a front upper location adjacent to the striker within body, the lever pressing upward upon the body at the lever front end;
a rear end of the lever links to the handle, and the lever presses the power spring wherein pressing the handle causes the power spring via the lever to deflect and store energy; and
wherein at the respective pre-release positions of handle and lever, the lever front end is immediately adjacent to the handle.

35. The stapling device of claim 34, wherein the lever presses the power spring at a pressing edge near a center of a length of the power spring is pivotably attached to the body near a rear end of the spring, and the lever front end, lever pressing edge, and power spring rear end are substantially collinear for all positions.

36. The stapling device of claim 35, wherein a cage at least partially confines the power spring to pre-load the power spring in a rest position, the combination of power spring and cage forming a power spring/cage subassembly, and the cage is pivotably attached to the body near a rear end of the power spring at a location separate from the pivotal attachment of the handle.
